(19) United States
(12) Patent Application Publication
(10) Pub. No.: US 2010/0173147 A1
(43) Pub. Date: Jul. 8, 2010

(54) Cationic, Energy-Cured Varnish With Microcapsules

(76) Inventors: Steven Greenland, Hampton, NH (US); Lyudmila Feldman, Hixson, TN (US); David M. Shenberger, Ocoee, TN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 12/663,817

(22) PCT Filed: Jun. 19, 2008
(86) PCT No.: PCT/US08/67491

§ 371 Date: Dec. 9, 2009

Related U.S. Application Data
(60) Provisional application No. 60/945,804, filed on Jun. 22, 2007.

(51) Int. Cl. C08F 2/46; C08J 7/04; B32B 5/16

(52) U.S. Cl. 428/323; 522/83; 427/515; 427/510

(57) ABSTRACT

A composition of matter comprising a cationic energy-cured epoxy material and a plurality of microcapsules. In some embodiments, cationic energy-cured epoxy material is a cationic UV-cured varnish. In some embodiments, the composition further comprises a viscosity modifier. The viscosity modifier comprises a viscosity reducer or a viscosity enhancer. A combination comprising a substrate and the composition of matter, and a method of applying the composition of matter to a substrate, are also described.

### PRIORITY

This application claims priority from U.S. Provisional Patent Application No. 60/945,804, filed Jun. 22, 2007, the disclosure of which is incorporated herein by reference as if fully set forth.

### BACKGROUND OF THE INVENTION

This invention relates to the field of applying microcapsules to a substrate using a binder. The invention will be described with reference to applying microcapsules containing a substance immiscible in water to a substrate using a binder, and more particularly to applying microcapsules containing a fragrance to a substrate using a binder, but the invention is not meant to be limited thereby. The invention as described herein can be used to apply any microcapsules to a broad range of substrates.

FIG. 1 shows a cross-section of a typical microcapsule 10 as used in the present invention. Although FIG. 1 shows a generally spherical microcapsule, in practice the shapes of microcapsules will vary widely. A microcapsule 10 comprises at least a filler 12 and a shell 14. The filler 12 can be a liquid, a solid, an emulsion, a suspension of solids within a liquid, or a suspension of smaller microcapsules within a liquid. The filler 12 is surrounded by the shell 14. There may be multiple shells in some applications. The function of the shell is to contain the filler material until the proper time to release the filler. The shell can be ruptured, dissolved, or melted, or breached in some other fashion.

In so-called “scratch-and-sniff” applications, the filler is usually a liquid containing fragrance oil. In these applications, the shell is usually ruptured by the user scratching or rubbing the surface.

In scratch-and-sniff applications, the microcapsules must be adhered to a substrate. Typically, the microcapsules are suspended in a liquid binder, the suspension is applied to the substrate, and the combination substrate/suspension is dried. As the binder dries, ideally the microcapsules suspended in the binder protrude from the surface of the dried binder. Scratching the surface therefore ruptures some of the shells, releasing the fragrance oil, and thereby exposing the user to the fragrance. FIG. 2 is a cross-sectional view of a scratch-and-sniff system 20 having a plurality of fragrance-containing microcapsules 22 embedded in a binder 24 which is applied to a substrate 26. Microcapsule 22A protrudes from the surface of binder 24, is intact, and therefore still contains filler 12. The shell 14, however, of microcapsule 22B, has been ruptured by scratching or rubbing and has released its filler 12.

Important criteria for a binder include that it provide strong adhesion to the microcapsules, that it provide strong adhesion of the microcapsules to the substrate, that the binder, once dry, be flexible, tough, and resistant to bending, and that the binder not flake off the substrate. Additionally, the binder components must not migrate through the shell of the microcapsule, cause premature migration of the filler out of the shell, cause degradation of the filler (such as fragrance deterioration caused by oxidation, hydrolysis, or other reactions), cause reactions between the filler and the shell, or change the properties of the shell (such as, for examples, color, permeability, and mechanical strength).

One commonly used type of binder material is a water soluble polymer resin. Selection of acceptable polymer resin solutions is substantially limited because of the need to provide stability and function within an unusual range of acceptable pH. Polymer solutions that require elevated pH for stable solution in water have been found largely unacceptable due to the tendency of these materials to chemically act on and degrade the microcapsule shell or volatile fragrance filler. In addition, water-soluble polymers tend to be highly oleophobic and are therefore largely unacceptable for direct application to many common hydrophobic substrates such as thermoplastics unless a surfactant or other compatibility agent is used in the binder solution. Such compatibility agents are also problematic and generally cause unwanted side effects with regard to the microcapsule shell and or the stability of the filler. The use of surfactants is also known to negatively impact the ability of fragrance components in the filler to volatilize and “lift” when the microcapsules are ruptured. Also, these water-soluble polymer solutions are slow to dry into a film when applied within the target wet film thickness. The production rate is often limited by the time required to dry the coating; therefore to minimize dry times and thereby maximize production, coatings are typically dried with the aid of high heat, which can be detrimental to many fragrance.

Commonly-used water-soluble polymer binders also suffer from lack of durability in conditions of elevated humidity. Actual resistance to humidity is substantially lowered even further when combined with elevated temperature. Such conditions may be routinely experienced in tropical, subtropical and even temperate climates during summer months. Water-soluble binder systems with secondary cross-link chemistry have been found to be of limited use in resolution of this issue due to compatibility issues created within the formulated suspension.

Another option for a suitable system is the use of a resin binder delivered from a volatile organic solvent-based solution. Such a system may also provide the desired reduction in the dry binder film thickness upon drying and film formation resulting as well in an exposed microcapsule profile. Since fragrance oils mix easily with most useful organic solvents, the microcapsule shell must be largely impermeable to the outward migration of the filler in the presence of the selected solvent. Most preferably, the volatile organic solvent used is toluene. Toluene-borne printing is routinely practiced and has become an environmentally acceptable option due the refinement of modern solvent reclamation practices. Toluene-based systems and manufacturing operations are fully incompatible with water. Therefore, water inherently present in the microcapsule shell must be carefully removed prior to any formulation with such systems. The microcapsules are dried into a dispersible powder before being added to the system, which is a difficult, expensive, and time-consuming process. Proper use of such volatile organic solvent systems is an environmental issue tightly controlled by regulation and requiring specific permits for operation within the United States. The primary printing method used with such a solvent system is gravure application. The maximum volume and size of microcapsules used must be substantially restricted below the ideal in order to flow and fit into the defined volume of the gravure print cells. For these reasons, the potential use and growth of such systems is substantially limited.

Another type of scratch and sniff system is based on combining the microcapsule shell material within an ink coating. The addition of microcapsules to ink dilutes the pigments, which can affect color. Typically, very small microcapsules must be used in order to limit color shift, decreasing the amount of fragrance released.

An alternative approach to solution binders is the use of non-volatile reactive chemistries that are curable upon exposure to ultraviolet radiation (“UV”). These free-flowing materials are hardened into solid film by a reactive polymerization process, either free-radical polymerization or cationic polymerization. The rate of the polymerization may be so rapid as to be considered almost instantaneous. Therefore, such alternative binders may be highly desirable with regard to production efficiency. Among the potential drawbacks to the potential use of such polymerization systems is that there is very little reduction in thickness upon curing, so the chance of microcapsules being completely imbedded within the polymerized layer of binder is much greater than with a solvent-based varnish. If a microcapsule is completely imbedded, it will not rupture upon scratching and the fragrance is therefore lost. For example, as shown in FIG. 3, microcapsule 32 is completely embedded in binder 34 which is applied to substrate 36. Accordingly, scratching or rubbing the surface of binder 34 will not rupture microcapsule 32, so the filler within microcapsule 32 is not available.

The primary method of polymerization cure used for such systems is the release of free radicals from a photo-initiator material on exposure to ultraviolet energy. Full polymerization of reactive components is not possible and is an inherent limitation of the technology. The actual quantity of residual uncured reactive components is highly variable depending on the exact process conditions. Changes in UV energy exposure are a common process issue due to changes in web speed and bulb aging. Free-radical cure is not considered a self-sustaining reaction and its progression to completion is not insured. Maximum cure may only be achieved by exposure to sufficiently high energy levels that are known to be detrimental to many fragrance chemistries. Moreover, free-radical UV-curable coatings and binders leave an odor that remains for a long time. The odor is generally unpleasant to users and also interferes with a fragrance encapsulated in the microcapsules.

In some applications, it is desirable to use fine fragrances as the filler. Fine fragrances are generally made natural oils that are very expensive to obtain from plants and flowers and that are very sensitive to temperature, to radiation such as ultraviolet radiation, and especially to oxygen. These fragrances generally are very complex in terms of a number of individual odorous chemicals.

A need exists for a binder that avoids one or more problems of the prior art. The present invention meets this need.

### BRIEF SUMMARY OF THE INVENTION

The present invention in a first embodiment is a composition of matter comprising a cationic energy-cured epoxy material and a plurality of microcapsules. In some embodiments, the cationic energy-cured material is a cationic ultraviolet-cured varnish. In some embodiments, the present invention further comprises a viscosity modifier. In another embodiment, the composition of matter is applied to a substrate. In yet another embodiment, microcapsules are applied to a substrate by printing the composition of matter on a substrate and curing the varnish.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying non-scale drawings, wherein like reference numerals identify like elements in which:

FIG. 1 is a cross-sectional view of a typical microcapsule as used in the preferred embodiments of the present invention.

FIG. 2 is a cross-sectional view of a typical scratch-and-sniff application of the preferred embodiment of the present invention.

FIG. 3 is a cross-sectional view of a scratch-and-sniff application as known in the prior art.

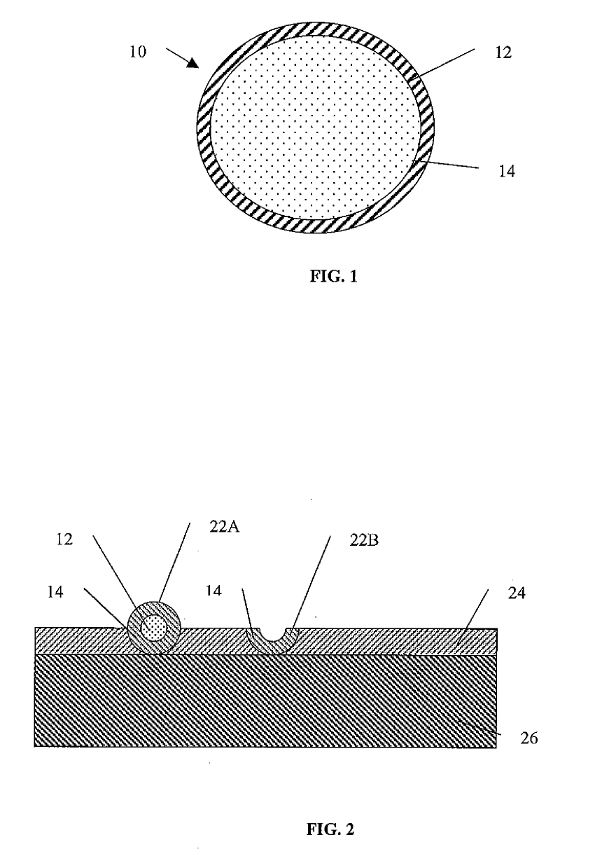

### DETAILED DESCRIPTION OF THE PREFERRED EMBODIMENTS OF THE INVENTION

While the invention may be susceptible to embodiment in different forms, there is shown in the drawings, and herein will be described in detail, specific embodiments with the understanding that the present disclosure is to be considered an exemplification of the principles of the invention, and is not intended to limit the invention to that as illustrated and described, herein.

The preferred embodiment of the present invention comprises a combination of microcapsules 22 and a binder 24, as shown in FIG. 2. Binder 24 comprises a cationic energy-cured epoxy material. The epoxy material is cured by an energy source. In one embodiment, the epoxy material comprises an ultraviolet-initiated cationic-cured epoxy material, sometimes called a cationic ultraviolet-cured varnish and hereinafter referred to in this application as “a cationic UV-cured varnish”. In other embodiments, the epoxy material is cured by other radiation sources. The invention will be described with use of a cationic UV-cured varnish by the invention is not meant to be limited thereby.

In some embodiments, the present invention further comprises a viscosity modifier. The viscosity modifier comprises a viscosity reducer or a viscosity enhancer.

Preferably, the microcapsules 22 contain fragrance oil as a filler 12. However, the filler 12 can be any other substance desired to be delivered by microcapsule and the invention is not limited to use with fragrances. Microcapsules 22 should be formed by a method that results in a very impermeable shell 14, to minimize losses of volatile fragrance components. Additionally, the method of forming the microcapsules 22 should not cause any chemical change in the fragrance components during any manufacturing stage, from microcapsule formation to curing of the varnish on the substrate 26.

Microcapsules are made by many methods and are commercially available. Preferably, microcapsule shell 14 is formed of polyoxymethylene urea (“PMU”). PMU microcapsules are preferably made as disclosed in U.S. Pat. No. 3,516,941, the disclosure of which in incorporated herein by reference. In other embodiments, microcapsules made by other polycondensation microencapsulation methods are used.

A cationic UV-cured varnish does not use solvents, does not require heat for drying, but instead may gel and solidify almost instantly upon exposure to UV radiation. Therefore, the present invention can be used with conventional printing processes of many types, requiring only a UV energy source and the potential for reduced production time as compared with the prior art coatings. Because the constituents of cationic UV-cured varnish are larger than the comparably smaller molecules of a solvent material, there is reduced potential for permeation of the material into the microcapsule shell. UV-initiated cationic-cured coatings exhibit excellent adhesion to the microcapsule shell material as well as to a broad range of substrates including hydrophobic surfaces.

Binder 24 contains an active photo-initiator compound. Upon exposure to ultraviolet light, the photo-initiator undergoes photolysis to generate a superacid, a highly efficient cationic species. This superacid serves as the catalyst for rapid polymerization of epoxides and secondary reaction of epoxides with hydroxyls. The photo-initiator compound is preferably of the type described in U.S. Pat. No. 4,058,401 to Crivello, the disclosure of which is incorporated herein by reference. A commercially-available example is the material produced by Ciba Specialty Chemicals and sold as Irgacure 250.

In the current invention, a supplemental photo-initiator compound may be added to binder 24. Most preferred are the photo-initiators sold by Sun Chemical and identified as product numbers 482-493 and 482-927. These photo-initiators may be blended in supplement with binder 24 to insure proper UV initiation and resulting cationic material release to achieve proper cure. Cycloaliphatic epoxides react particularly rapidly to crosslink with each other, with hydroxyl compounds, and with vinyl compounds. This rapid cure is particularly advantageous because it provides for increased production rates as compared with existing aqueous-based scratch-and-sniff coating systems.

Various embodiments of binder 24 are described in U.S. Pat. No. 5,674,922 to Igarashi and U.S. Pat. No. 6,232,361 to Laksin, the disclosures of both of which are incorporated herein by reference. Preferably, binder 24 is UV Flexo Extender, marketed under the product designation FLHFV0650312 by Sun Chemical Corp. This binder will efficiently absorb some of the major energy wave bands of standard mercury-type UV emitting bulbs to initiate polymerization induced by the release of cationic species.

Additionally, this binder 24 has minimum odor, does not contain components that attack the microcapsule shell 14, cures quickly to minimize the need for fragrance exposure to UV radiation and heat, and does not chemically or physically deteriorate or attack the microcapsule filler 22 during any stage of manufacturing. Once properly initiated, the cationic polymerization of binder 24 will generally progress until all reactive components are consumed. After full cure is achieved, the resulting matrix has an extremely low odor profile that is highly desirable for the presentation of volatile fragrance. The present invention also results in an improved scratch-and-sniff system that is highly resistant to failure on exposure to various climate extremes. Elevated humidity and temperature have minimal impact on the adhesion of binder 24 to the target substrate. As well, binder 24 serves to supplement the barrier properties provided by the preferred PMU microcapsule shell in preventing premature loss or degradation of the contained filler.

The preferred embodiment of binder 24 has been found to be uniquely advantageous when used as a scratch-and-sniff binder in combination with the preferred PMU microcapsule shell. The value of epoxy compounds for use as a supplemental barrier in combination with PMU microcapsules is described in U.S. Pat. No. 4,209,188 to Chao, the disclosure of which is incorporated herein by reference. Additionally, U.S. Pat. No. 7,202,286 to Hatton, the disclosure of which is incorporated herein by reference, lends further support to the theory of advantageous chemical synergy between the chemistry of the PMU microcapsule and the cationic UV-cured binder. Another advantageous utility of the PMU microcapsules in UV-initiated cure systems is that PMU microcapsule shell is completely transparent.

There is a synergistic effect produced by the combination of UV-initiated cationic-cured epoxy-type binders with PMU microcapsules. The combination is uniquely compatible, as demonstrated by the facts that the end product is stable and produces perfect rendition. Accordingly, the combination produces a formulated scratch and sniff coating (SNS) with superior performance characteristics for standard aqueous coatings while also being suitable for use with fine fragrances with respect to scent reproduction, rendition and long term stability.

UV-initiated cationic-cured epoxy-type binders may be formulated in such a way as to be uniquely tolerant to the presence of water without significant impact on the ability to polymerize, as described in the '361 patent to Laksin. This attribute provides the potential for significant cost savings by eliminating or reducing the need for full dehydration of the PMU or other polycondensation microcapsules prior to formulation with the binder that is otherwise required.

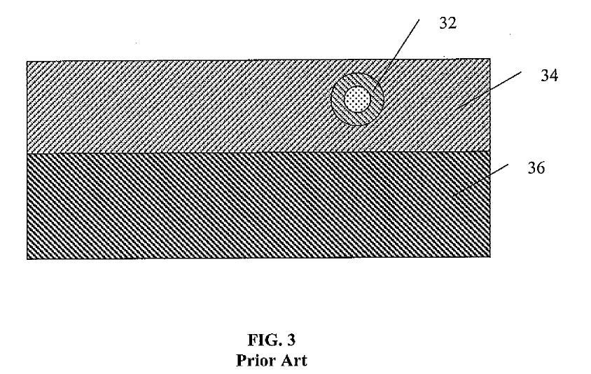

The combination of fragrance-containing microcapsules 22 and binder 24 may be advantageously used for scratch-and-sniff applications. In order to avoid the problem of microcapsules being completely embedded within binder 24, as shown in FIG. 3, the material is preferably printed in such a manner so as to create discrete textured patterns. When properly executed, such patterns result in a portion of the microcapsule profile extending above the plane of the binder 24. Textured patterns may be induced into the printed deposit by various means including but not limited to anilox cell structures, gravure cell structures, silk screen printing mesh, and patterned flexographic print plates. Additionally, the microcapsule size selected for use may be advantageously adjusted so as to provide improved texture specific to the desired print process and cured film thickness. Binder 24 may be reduced in viscosity with a co-reactive low-viscosity material, or otherwise modified with a viscosity enhancer, as is required to achieve proper resolution of the desired texture pattern or otherwise adjust the flexibility and hardness of the resulting cured deposit matrix.

In one embodiment, a complex mixture of fragrance-containing microcapsules 22 and binder 24 comprising 50 to 70 percent Sun Chemical UV Flexo Extender FLHFV0650312, blended with 30 to 50 percent Viscosity Reducer Sun Chemical No. 256-417, and two to five percent Sun Chemical UV Photo-initiator 482-493 or 482-927, is applied to the surface of a polyester label or other flexible web 26 using a flexographic printing process. Preferably, the microcapsules 22 have a mean capsule diameter size in the range of about 20 to 50 microns. The microcapsules 22 preferably constitute about five to 40 percent by weight, most preferably 20 to 35 percent, of the total weight of the formulated microcapsule and binder mixture. The resulting microcapsule and binder mixture preferably has a viscosity in the range of 20 to 70 seconds, most preferably 20 to 30 seconds (Zahn Cup No. 5). The formulated capsule and binder mixture is applied to labels or to a flexible web application 26, preferably using a 55 quad engraved anilox two-roll metering system. A mercury arc lamp, such as a SpectraCure Model 3012-1CT available from UV Research, is used for curing. Preferably, the ratio of mean microcapsule size to the maximum cured coating thickness as measured at the apex of the textured coating is in the range of about 0.5 to 1.0.

In another embodiment, fragrance-containing microcapsules 22 are applied to a substrate 26 in a cationic UV-cured binder 24, using traditional screen printing. Preferably, the microcapsules 22 have a mean diameter in the range of 15 to 30 microns and are mixed into the binder 24. Binder 24 in this embodiment comprises 95 to 99 percent Sun Chemical UV Flexo Extender FLHFV0650312 and one to five percent fumed silica such as Cab-o-sil® M-5 from Cabot Corporation. In other embodiments, other viscosity enhancers, including but not limited to other fumed silicas, micronized silica, fumed aluminum oxide, and other thixotropic viscosity-building additives, are used. The microcapsules 22 preferably constitute about 20 to 35 percent by weight of the total weight of the composition. The ratio of mean capsule diameter to textured coating thickness is in the range of about 0.5 to 1.0. Please note that the final viscosity of the formulated system prior to cure depends on the printing method selected. The formulated microcapsule UV-initiated binder mixture with microcapsules comprising about 25 percent by weight of the mixture were found to have a resulting viscosity between 27,000 and 36,000 Centipoise (“cps”). The formulated microcapsule mixture may be applied to the target substrate using a screen printing mesh in the range of 160 to 355 lines per inch. Screens in the range of 230 to 355 lines per inch are most preferred. Viscosity-enhancing fumed silica such as Cab-o-sil® M-5 from Cabot Corporation provides modification to the formulated mixture to prevent screen run out without measurable negative impact on attributes of adhesion or fragrance delivery. Please note that, in this example, no supplemental photo-initiator is utilized.

In yet another embodiment, fragrance-containing microcapsules 22 mixed with binder 24 may also be applied to a substrate 26 by UV method of offset lithography.

Premixed UV-initiated cationic cured epoxy type binder as described herein can be stored without loss of fragrance character. Fragrance odor on paper and on polyethylene terephthalate (PET) demonstrates satisfactory stability after four weeks at 45 C in a convection oven.

Binder 24 with fragrance-containing microcapsules 22 can be applied under standard conditions to high-gloss printed matter with 100 percent ink coverage, and can also be applied under standard conditions to polyvinyl chloride, PET, polycarbonate, and polyolefin films without surface pre-treatment. Binder 24 cures almost instantly and most fragrance-filled microcapsules 22 do not significantly impact the curing reaction. The polymerization reaction of the epoxy type binder will generally proceed to completion once properly initiated and does not depend on the actual duration of UV energy exposure. Some fragrances with high UV-absorbing species, such as cinnamates, benzophenone, and bergamot, may require an adjustment in the formula or process conditions.

The UV-initiating wavelength may be altered by the substitution of an iron halide-type UV radiation source in lieu of more common mercury lamps. In yet other embodiments, binder 24 is cured using a different radiation source, an electron beam being but one example. Other aspects of these embodiments are the same as described above.

While preferred embodiments of the present invention are shown and described, it is envisioned that those skilled in the art may devise various modifications of the present invention without departing from the spirit and scope of the appended claims.

The invention that is claimed is:

1. A composition of matter comprising a cationic energy-cured epoxy material and a plurality of microcapsules.

2. The composition of claim 1, wherein said microcapsules comprise a filler comprising a fragrance.

3. The composition of claim 1, wherein said microcapsules comprise a shell comprising a polyoxymethylene urea.

4. The composition of claim 1, wherein said cationic energy-cured epoxy material comprises a cationic UV-cured varnish.

5. The composition of claim 4, wherein said composition further comprises a supplemental photo-initiator.

6. The composition of claim 9, wherein said supplemental photo-initiator comprises about two to five percent by weight of said composition.

7. The composition of claim 4, further comprising a viscosity modifier.

8. The composition of claim 7, wherein said viscosity modifier comprises a viscosity reducer or a viscosity enhancer.

9. The composition of claim 8, wherein said composition has a viscosity of about 20 to 70 seconds (Zahn Cup No. 5).

10. The composition of claim 9, wherein said composition has a viscosity of about 20 to 30 seconds (Zahn Cup No. 5).

11. The composition of claim 7, wherein said varnish comprises about 50 to 70 percent by weight of said composition, said viscosity modifier is a viscosity reducer, and said viscosity reducer comprises about 30 to 50 percent by weight of said composition.

12. The composition of claim 11, wherein a mean capsule diameter size of said microcapsules is in the range of about 20 to 50 microns.

13. The composition of claim 7, wherein said varnish comprises about 95 to 99 percent by weight of said composition, said viscosity modifier is a viscosity enhancer, and said viscosity enhancer comprises about one to five percent by weight of said composition.

14. The composition of claim 13, wherein said viscosity enhancer comprises a thixotropic additive.

15. The composition of claim 14, wherein said additive comprises at least one of a fumed silica and a micronized silica.

16. The composition of claim 13, wherein a viscosity of said composition is about 27,000 to 36,000 cps.

17. The composition of claim 13, wherein a mean capsule diameter size of said microcapsules is in the range of about 15 to 30 microns.

18. A system comprising:
a substrate and a composition of matter applied to said substrate, said composition comprising a cationic energy-cured epoxy material and a plurality of microcapsules.

19. The system of claim 18, wherein said microcapsules comprise a filler comprising a fragrance.

20. The system of claim 18, wherein said microcapsules comprise a shell comprising a polyoxymethylene urea.

21. The system of claim 18, wherein said cationic energy-cured epoxy material comprises a cationic UV-cured varnish.

22. The system of claim 21, wherein said composition further comprises a supplemental photo-initiator.

23. The system of claim 22, wherein said supplemental photo-initiator comprises about two to five percent by weight of said composition.

24. The system of claim 21, further comprising a viscosity modifier.

25. The system of claim 24, wherein said viscosity modifier comprises a viscosity reducer or a viscosity enhancer.

26. The system of claim 24, wherein said composition has a viscosity of about 20 to 70 seconds (Zahn Cup No. 5).

27. The system of claim 26, wherein said composition has a viscosity of about 20 to 30 seconds (Zahn Cup No. 5).

28. The system of claim 24, wherein said varnish comprises about 50 to 70 percent by weight of said composition, said viscosity modifier is a viscosity reducer, and said viscosity reducer comprises about 30 to 50 percent by weight of said composition.

29. The composition of claim 24, wherein a mean capsule diameter size of said microcapsules is in the range of about 20 to 50 microns.

30. The system of claim 24, wherein said varnish comprises about 95 to 99 percent by weight of said composition, said viscosity modifier is a viscosity enhancer, and said viscosity enhancer comprises about one to five percent by weight of said composition.

31. The system of claim 30, wherein said viscosity enhancer comprises a thixotropic additive.

32. The system of claim 31, wherein said additive comprises at least one of a fumed silica and a micronized silica.

33. The system of claim 30, wherein a viscosity of said composition is about 27,000 to 36,000 cps.

34. The system of claim 24, wherein a mean capsule diameter size of said microcapsules is in the range of about 15 to 30 microns.

35. The system of claim 24, wherein said substrate comprises a label.

36. The system of claim 24, wherein said substrate comprises a web.

37. The system of claim 24, wherein said composition is applied to said substrate in discrete textured patterns.

38. The system of claim 37, wherein said composition is applied by anilox cell structures, gravure cell structures, silk screen printing mesh, patterned flexographic print plates, screen printing, or offset lithography.

39. A method of applying microcapsules to a substrate, the method comprising:
applying a composition of matter onto a substrate, said composition comprising a cationic energy-cured epoxy material and a plurality of microcapsules; and
curing said composition with an energy source after said applying step.

40. The method of claim 39, wherein said energy source comprises an ultraviolet lamp.

41. The method of claim 40, wherein said ultraviolet lamp comprises a mercury arc lamp.

42. The method of claim 39, wherein said radiation source comprises an e-beam.

43. The method of claim 39, wherein said microcapsules comprise a filler comprising a fragrance.

44. The method of claim 39, wherein said microcapsules comprise a shell comprising a polyoxymethylene urea.

45. The method of claim 39, wherein said cationic energy-cured epoxy material comprises a cationic UV-cured varnish.

46. The method of claim 45, wherein said composition further comprises a supplemental photo-initiator.

47. The method of claim 46, wherein said supplemental photo-initiator comprises about two to five percent by weight of said composition.

48. The method of claim 39, further comprising a viscosity modifier.

49. The method of claim 48, wherein said viscosity modifier comprises a viscosity reducer or a viscosity enhancer.

50. The method of claim 48, wherein said composition has a viscosity before said curing step of about 20 to 70 seconds (Zahn Cup No. 5).

51. The method of claim 50, wherein said composition has a viscosity before said curing step of about 20 to 30 seconds (Zahn Cup No. 5).

52. The method of claim 48, wherein said varnish comprises about 50 to 70 percent by weight of said composition, said viscosity modifier is a viscosity reducer, and said viscosity reducer comprises about 30 to 50 percent by weight of said composition.

53. The method of claim 52, wherein a mean capsule diameter size of said microcapsules is in the range of about 20 to 50 microns.

54. The method of claim 48, wherein said varnish comprises about 95 to 99 percent by weight of said composition, said viscosity modifier is a viscosity enhancer, and said viscosity enhancer comprises about one to five percent by weight of said composition.

55. The method of claim 54, wherein a mean capsule diameter size of said microcapsules is in the range of about 15 to 30 microns.

56. The method of claim 54, wherein said viscosity enhancer comprises a thixotropic additive.

57. The method of claim 56, wherein said additive comprises at least one of a fumed silica and a micronized silica.

58. The method of claim 57, wherein a viscosity of said composition is about 27,000 to 36,000 cps.

59. The method of claim 39, wherein said substrate comprises a label.

60. The method of claim 39, wherein said substrate comprises a web.

61. The method of claim 39, wherein said applying step comprises applying said composition in discrete textured patterns.

62. The method of claim 61, wherein said applying step comprises use of anilox cell structures, gravure cell structures, silk screen printing mesh, patterned flexographic print plates, screen printing, or offset lithography.

63. A composition of matter composition comprising a cationic energy-cured epoxy material and a plurality of microcapsules, said microcapsules having a shell, wherein there is a chemical synergy between the chemistry of said shell and the chemistry of said epoxy material.

64. A combination comprising the composition of matter of claim 60 and a substrate.

65. A method of applying microcapsules to a substrate, the method comprising:
applying a composition of matter onto a substrate, said composition comprising a cationic energy-cured epoxy material and a plurality of microcapsules; and
curing said composition with an energy source after said applying step.
